(19) United States
(12) Patent Application Publication
(10) Pub. No.: US 2014/0094340 A1
(43) Pub. Date: Apr. 3, 2014

(54) CONTROL DEVICE AND CONTROL METHOD FOR VEHICLE

(71) Applicants: Masato YOSHIKAWA, Susono-shi (JP); Naoki NAKANISHI, Susono-shi (JP); Shintaro MATSUTANI, Toyota-shi (JP)

(72) Inventors: Masato YOSHIKAWA, Susono-shi (JP); Naoki NAKANISHI, Susono-shi (JP); Shintaro MATSUTANI, Toyota-shi (JP)

(73) Assignee: TOYOTA JIDOSHA KABUSHIKI KAISHA, Toyota-shi (JP)

(21) Appl. No.: 14/041,384

(22) Filed: Sep. 30, 2013

(30) Foreign Application Priority Data
Oct. 2, 2012 (JP) 2012-220768

(51) Int. Cl. B60W 20/00

(52) U.S. Cl. CPC B60W 20/10; Y10S 903/902
USPC 477/5; 180/65.275; 903/902

(57) ABSTRACT

A controller of a vehicle control device, at the time of shifting from a motor drive mode to an engine drive mode by starting an engine in the motor drive mode, starts the engine by slipping an engine separating clutch and igniting the engine in a state where a lockup clutch of a fluid transmission device is slipped. The fluid transmission device is interposed between an electric motor and a drive wheel. The engine separating clutch selectively couples the engine to the electric motor. Only the electric motor is a drive source in the motor drive mode. The engine is a drive source in the engine drive mode. The controller, at the time of the shifting, reduces a slip amount of the lockup clutch as a period of time from slip initiation timing of the engine separating clutch to ignition initiation timing of the engine extends.

### INCORPORATION BY REFERENCE

The disclosure of Japanese Patent Application No. 2012-220768 filed on Oct. 2, 2012 including the specification, drawings and abstract is incorporated herein by reference in its entirety.

### BACKGROUND OF THE INVENTION

1. Field of the Invention

The invention relates to improvement in control for starting an engine in a hybrid vehicle.

2. Description of Related Art

There is known a vehicle that includes an engine, an electric motor, an input clutch that selectively couples the engine to the electric motor, and a torque converter having a lockup clutch and interposed between the electric motor and drive wheels. A control device for such a vehicle is, for example, described in Japanese Patent Application Publication No. 2001-032922 (JP 2001-032922 A). When the control device for a vehicle, described in JP 2001-032922 A, shifts from a motor drive mode in which only the electric motor is used as a drive source to an engine drive mode in which the engine is used as a drive source, the control device shifts into the engine drive mode by starting the engine in a state where the lockup clutch is slipped.

### SUMMARY OF THE INVENTION

In JP 2001-032922 A, the control device for a vehicle starts the engine in a state where the lockup clutch is slipped; however, it is not clear how a slip amount of the lockup clutch is controlled. For example, if the slip amount of the lockup clutch at the time of starting the engine is increased, it is easy to avoid occurrence of an engagement shock through unattended complete engagement of the lockup clutch due to torque fluctuations of the engine, or the like; but then it is assumed that fuel economy deteriorates. On the other hand, if the slip amount of the lockup clutch is reduced, it is possible to improve fuel economy; but then it is assumed that the probability of occurrence of the engagement shock of the lockup clutch increases. Thus, there is presumably still room for improvement in the control device for a vehicle, described in JP 2001-032922 A, in terms of achieving both fuel economy and drivability. The above-described problem is not in public domain.

The invention provides a control device and control method for a vehicle including an engine and an electric motor, which are able to achieve both fuel economy and drivability at the time of shifting from the motor drive mode to the engine drive mode.

A first aspect of the invention relates to a control device for a vehicle. The vehicle includes an engine, an electric motor, an engine separating clutch and a fluid transmission device. The control device includes a controller. The controller is configured to, at the time of shifting from a motor drive mode to an engine drive mode by starting the engine in the motor drive mode, start the engine by slipping the engine separating clutch and igniting the engine in a state where a lockup clutch included in the fluid transmission device is slipped. The fluid transmission device is interposed between the electric motor and a drive wheel. The engine separating clutch is configured to selectively couple the engine to the electric motor. Only the electric motor is a drive source in the motor drive mode. The engine is a drive source in the engine drive mode. The controller is configured to, at the time of the shifting, reduce a slip amount of the lockup clutch as a period of time from timing at which a slip of the engine separating clutch is initiated to timing at which ignition of the engine is initiated extends.

In starting the engine of the vehicle, as a period of time from timing at which a slip of the engine separating clutch is initiated to timing at which ignition of the engine is initiated (hereinafter, referred to as ignition initiation required time) reduces, an initial rise of an engine torque immediately after initiation of ignition of the engine is steep and engine torque fluctuations increase, so the controllability of the engine torque is poor. Therefore, for example, when the engine torque immediately after initiation of ignition of the engine becomes temporarily smaller than the command value and the slip amount of the lockup clutch is insufficient for the temporary engine torque fluctuations, the lockup clutch being slipped can be inadvertently completely engaged, and, as a result, an engagement shock can occur. In contrast to this, according to the first invention, as the controllability of the engine torque at the time of the engine start deteriorates, the slip amount of the lockup clutch is increased, so it is possible to avoid occurrence of the engagement shock by the adequate slip amount. In addition, as the ignition initiation required time extends, the controllability of the engine torque improves and an engagement shock of the lockup clutch becomes hard to occur, so it is possible to improve fuel economy by reducing the slip amount of the lockup clutch accordingly. In this way, it is possible to achieve both fuel economy and drivability at the time of shifting from the motor drive mode to the engine drive mode. For example, fuel economy is a travel distance per unit fuel consumption, or the like, and improvement in fuel economy means that the travel distance per unit fuel consumption extends or a fuel consumption rate (=fuel consumption/drive wheel output) of the entire vehicle reduces. Conversely, a decrease (deterioration) in fuel economy means that the travel distance per unit fuel consumption reduces or the fuel consumption rate of the entire vehicle increases.

In the control device, the controller may be configured to reduce the slip amount of the lockup clutch as a rotation speed of output of the fluid transmission device increases. Here, when the engine rotation speed that is increased at the time of the engine start is low, the startability of the engine deteriorates. In this respect, according to the second invention, even when the output rotation speed of the fluid transmission device is low, the engine rotation speed is increased to a certain high speed due to a slip of the lockup clutch at the time of the engine start, so it is possible to suppress deterioration of engine startability due to the low output rotation speed of the fluid transmission device.

In the control device, the engine may be a direct-injection engine, the controller may be configured to start the engine with the use of any one of a first engine start method, a second engine start method and a third engine start method, the controller may be configured to, in the first engine start method, initiate ignition of the engine simultaneously with initiation of a slip of the engine separating clutch or before the initiation of the slip, the controller may be configured to, in the second engine start method, initiate ignition of the engine within a period from initiation of a slip of the engine separating clutch to when the engine separating clutch is completely engaged, the controller may be configured to, in the third engine start method, initiate ignition of the engine after the engine separating clutch has been completely engaged from a state where the engine separating clutch is slipped, the controller may be configured to reduce the slip amount of the lockup clutch when the engine is started with the use of the third engine start method as compared to when the engine is started with the use of the second engine start method, and the controller may be configured to reduce the slip amount of the lockup clutch when the engine is started with the use of the second engine start method as compared to when the engine is started with the use of the first engine start method. With this configuration, the slip amount of the lockup clutch is set to an appropriate amount on the basis of a specific engine start method, so, even when any one of the engine start methods is employed, it is possible to achieve both fuel economy and drivability at the time of shifting from the motor drive mode to the engine drive mode.

A second aspect of the invention relates to a control method for a vehicle including an engine, an electric motor, an engine separating clutch and a fluid transmission device. The control method includes, at the time of shifting from a motor drive mode to an engine drive mode by starting the engine in the motor drive mode, starting the engine by slipping the engine separating clutch and igniting the engine in a state where a lockup clutch included in the fluid transmission device is slipped. The fluid transmission device is interposed between the electric motor and a drive wheel. The engine separating clutch is configured to selectively couple the engine to the electric motor. Only the electric motor is a drive source in the motor drive mode. The engine is a drive source in the engine drive mode. The control method includes, at the time of the shifting, reducing a slip amount of the lockup clutch as a period of time from timing at which a slip of the engine separating clutch is initiated to timing at which ignition of the engine is initiated extends.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that conceptually shows the configuration of a drive system of a hybrid vehicle according to an embodiment of the invention;

FIG. 2 is a cross-sectional view of a portion around a combustion chamber of a direct-injection engine of the hybrid vehicle shown in FIG. 1;

FIG. 3 is a functional block diagram for illustrating a relevant portion of control functions included in an electronic control unit shown in FIG. 1;

FIG. 4 is a graph that shows an empirically preset correlation, that is, a slip amount setting value map, between a slip amount setting value and a transmission input rotation speed, which the electronic control unit shown in FIG. 1 uses in order to determine a slip amount setting value of a lockup clutch;

FIG. 5 shows time charts in the case where the engine is started with the use of each of first to third engine start methods in the hybrid vehicle shown in FIG. 1;

FIG. 6 is a flowchart for illustrating a relevant portion of control operations of the electronic control unit shown in FIG. 1, that is, control operations for starting the engine at the time of shifting from a motor drive mode to an engine drive mode;

FIG. 7 shows time charts in which the engine is started with the use of the first engine start method in motor drive operation in the hybrid vehicle shown in FIG. 1; and

FIG. 8 is a graph that shows an empirically preset correlation, that is, an engagement hydraulic pressure setting value map, between an engagement hydraulic pressure setting value and a transmission input rotation speed, which the electronic control unit shown in FIG. 1 uses to determine an engagement hydraulic pressure setting value instead of a slip amount setting value of the lockup clutch.

### DETAILED DESCRIPTION OF EMBODIMENTS

Hereinafter, an embodiment of the invention will be described in detail with reference to the accompanying drawings.

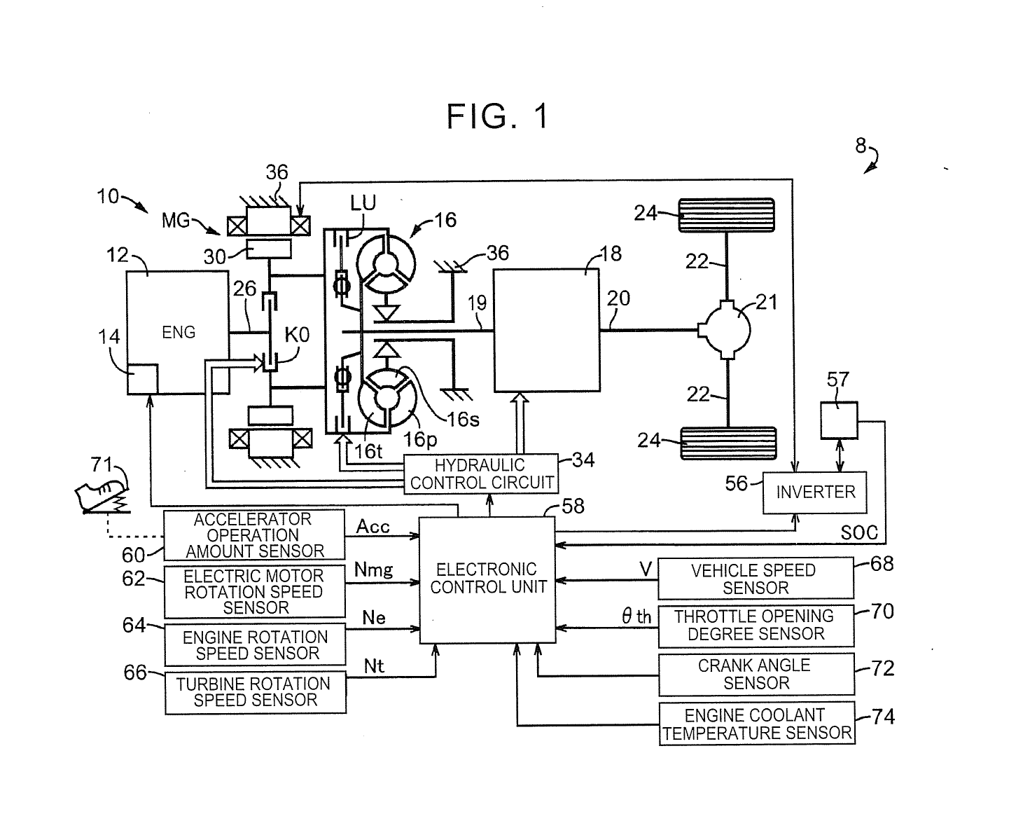

FIG. 1 is a view that conceptually shows the configuration of a drive system of a hybrid vehicle 8 (hereinafter, simply referred to as “vehicle 8”) according to the embodiment of the invention. The hybrid vehicle 8 shown in FIG. 1 includes a vehicle drive device 10 (hereinafter, referred to as “drive device 10”), a differential gear unit 21, a pair of right and left axles 22, a pair of right and left drive wheels 24, a hydraulic control circuit 34, an inverter 56 and an electronic control unit 58. The drive device 10 includes an engine 12, an engine output control unit 14, an electric motor MG, an engine separating clutch K0, a torque converter 16 and an automatic transmission 18. The engine 12 can function as a traveling drive source. The engine output control unit 14 starts or stops the engine 12 and executes engine output control, such as throttle control. The electric motor MG is a traveling electric motor that can function as a traveling drive source. As shown in FIG. 1, the vehicle 8 is configured such that power generated by one or both of the engine 12 and the electric motor MG is transmitted to the pair of right and left drive wheels 24 via the torque converter 16, the automatic transmission 18, the differential gear unit 21 and the pair of right and left axles 22. Therefore, in the vehicle 8, it is possible to alternatively select a motor drive mode in which only the electric motor MG is used as the drive source and an engine drive mode in which the engine 12 is used as the drive source. In the present embodiment, vehicle traveling in the motor drive mode is termed motor traveling, and vehicle traveling in the engine drive mode is termed engine traveling. That is, motor traveling is vehicle traveling in which the vehicle travels using only the power of the electric motor MG, and engine traveling is vehicle traveling in which the vehicle travels using the power of the engine 12. In addition, in the engine traveling, the electric motor MG may generate assist torque on the basis of a travel state.

The electric motor MG is coupled to the drive wheels 24, and is, for example, a three-phase synchronous electric motor. The electric motor MG is a motor generator that has the function of a motor that generates power and the function of a generator that generates reaction force. For example, the electric motor MG generates vehicle braking force through regenerative operation. In addition, the electric motor MG is electrically connected to an electrical storage device 57 via the inverter 56, and the electric motor MG and the electrical storage device 57 are configured to be able to exchange electric power with each other. The electrical storage device 57 is, for example, a battery (secondary battery) such as a lead-acid battery, a capacitor, or the like.

The engine separating clutch K0 formed of a generally known multiplate wet hydraulic friction engagement device is provided in a power transmission path between the engine 12 and the electric motor MG The engine separating clutch K0 functions as a power separating device that is actuated by hydraulic pressure supplied from the hydraulic control circuit 34 and that selectively couples the engine 12 to the electric motor MG Specifically, an engine output shaft 26 (for example, crankshaft) that is an output member of the engine 12 is relatively non-rotatably coupled to a rotor 30 of the electric motor MG by engaging the engine separating clutch K0, and is separated from the rotor 30 of the electric motor MG by releasing the engine separating clutch K0. In short, the engine output shaft 26 is configured to be selectively coupled to the rotor 30 of the electric motor MG via the engine separating clutch K0. Thus, the engine separating clutch K0 is completely engaged in the engine drive mode, and is released in the motor drive mode. The rotor 30 of the electric motor MG is relatively non-rotatably coupled to a pump impeller 16p that is an input member of the torque converter 16.

The automatic transmission 18 constitutes part of the power transmission path between the torque converter 16 and the drive wheels 24, and transmits the power of the engine 12 or electric motor MG to the drive wheels 24. The automatic transmission 18 is, for example, a step-shift automatic transmission that carries out clutch-to-clutch shift by engaging one of engagement elements and releasing another one of the engagement elements in accordance with a relationship (shift line map) preset on the basis of a vehicle speed V and an accelerator operation amount Acc. In other words, the automatic transmission 18 is an automatic shift mechanism in which any one of a plurality of preset speeds (speed ratios) is alternatively established. In order to carry out the shift, the automatic transmission 18 is configured to include a plurality of planetary gear units and a plurality of clutches or brakes that are actuated by hydraulic pressures from the hydraulic control circuit 34. The speed ratio of the automatic transmission 18 is calculated from the mathematical expression that “Speed ratio=Transmission input rotation speed Natin/Transmission output rotation speed Natout”.

The torque converter 16 is a fluid transmission device interposed between the electric motor MG and the drive wheels 24. The torque converter 16 includes the pump impeller 16p, a turbine impeller 16t and a stator impeller 16s. The pump impeller 16p is an input-side rotating element to which the power of the engine 12 and the power of the electric motor MG are input. The turbine impeller 16t is an output-side rotating element that outputs power to the automatic transmission 18. The torque converter 16 transmits power, input to the pump impeller 16p, to the turbine impeller 16t via fluid (hydraulic fluid). The stator impeller 16s is coupled to a transmission case 36 via a one-way clutch. The transmission case 36 is a non-rotating member. The torque converter 16 includes a lockup clutch LU between the pump impeller 16p and the turbine impeller 16t. The lockup clutch LU selectively directly couples the pump impeller 16p and the turbine impeller 16t to each other. The lockup clutch LU is controlled by hydraulic pressure from the hydraulic control circuit 34.

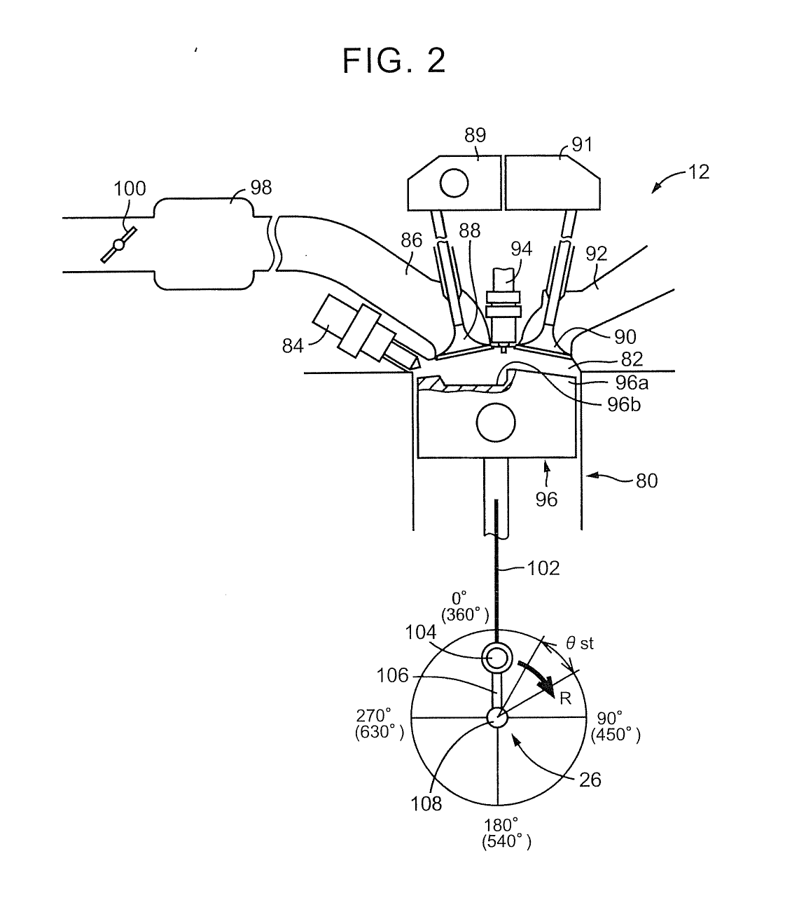

The engine 12 is a V-eight four-cycle direct-injection gasoline engine in the present embodiment. As is specifically shown in FIG. 2, the engine 12 is configured such that gasoline is directly injected by each fuel injection device 84 in a high-pressure fine particle state into a corresponding combustion chamber 82 formed in each cylinder 80. The engine 12 is configured such that air flows from an intake passage 86 into each combustion chamber 82 via a corresponding intake valve 88 and exhaust gas is emitted from each combustion chamber 82 to an exhaust passage 92 via a corresponding exhaust valve 90. An air-fuel mixture in each combustion chamber 82 is combusted by being ignited by a corresponding ignition device 94 at predetermined timing, and a corresponding piston 96 is pushed downward. The intake valves 88 are reciprocally moved in synchronization with rotation of the crankshaft 26 by an intake valve drive device 89 formed of a cam mechanism of the engine 12. Thus, the intake valves 88 are opened or closed. In addition, the exhaust valves 90 are reciprocally moved in synchronization with rotation of the crankshaft 26 by an exhaust valve drive device 91 formed of a cam mechanism of the engine 12. Thus, the exhaust valves 90 are opened or closed. The intake passage 86 is connected to an electronic throttle valve 100 via a surge tank 98. The electronic throttle valve 100 is an intake air amount adjustment valve that is opened or closed by an electric actuator. The intake air amount flowing from the intake passage 86 into each combustion chamber 82, that is, an engine output, is controlled on the basis of an opening degree 0th of the electronic throttle valve 100 (throttle opening degree θth). As shown in FIG. 2, each piston 96 has a piston head portion 96a that is a combustion chamber 82-side end portion and that forms part of the corresponding combustion chamber 82. The piston head portion 96a is formed of a recess 96b, that is, a cavity, that is open toward the corresponding combustion chamber 82. Each piston 96 is fitted in a corresponding one of cylinders 80 so as to be slidable in the axial direction, and is relatively rotatably coupled to a crank pin 104 of the engine output shaft (crankshaft) 26 via a connecting road 102. The crankshaft 26 is driven for rotation as indicated by the arrow R in accordance with linear reciprocal motion of each piston 96. The crankshaft 26 is rotatably supported by a bearing at each journal portion 108, and integrally includes crank arms 106, each of which connects the corresponding journal portion 108 to the corresponding crank pin 104. The shape, such as depth, of the recess 96b provided in each piston 96 is set such that an easily ignitable rich air-fuel mixture is formed and a favorable combustion is obtained while the engine 12 is being normally driven. The easily ignitable rich air-fuel mixture is formed such that fuel injected from the corresponding fuel injection device 84 is reflected inside the recess 96b and fuel is adequately distributed around the ignition device 94. While the engine 12 is being normally driven, fuel is injected in a compression stroke of each cylinder 80.

In the above engine 12, four strokes, that is, an intake stroke, a compression stroke, an expansion stroke (combustion stroke) and an exhaust stroke, are carried out in two rotations (720°) of the crankshaft 26 for one cylinder, and the crankshaft 26 is continuously rotated by repeating these strokes. The pistons 96 of the eight cylinders 80 are respectively configured such that crank angles are shifted by 90° from each other, in other words, the positions of the crank pins 104 of the crankshaft 26 protrude in directions shifted by 90° from each other. Each time the crankshaft 26 rotates by 90°, the eight cylinders 80 are subjected to combustion in a preset ignition order, and rotation torque is continuously generated. Because the engine 12 is a direct-injection engine, the engine is allowed to be started through ignition start in which fuel is injected into each cylinder 80 and ignited from the very beginning of rotation of the engine 12. More specifically, the ignition start, that is, preignition, is an engine start method in which, when the crankshaft 26 rotates by a predetermined angle from a compression top dead center (compression TDC) after the compression stroke of one of the pistons 96 and is stopped within a predetermined angular range θst of the expansion stroke in which both the corresponding intake valve 88 and the corresponding exhaust valve 90 are closed, gasoline is initially injected by the corresponding fuel injection device 84 into the corresponding cylinder 80 (into the corresponding combustion chamber 82) in the expansion stroke and is ignited by the corresponding ignition device 94, thus causing the air-fuel mixture in that cylinder 80 to combust and raising an engine rotation speed Ne. The ignition start is able to start the engine without cranking with the use of the electric motor MG, or the like; however, in the present embodiment, the ignition start is carried out when the engine 12 is started during the motor traveling as well. At this time, in order to increase the startability of the engine 12, slip engagement (also simply referred to as slip) for slipping the engine separating clutch K0 is carried out, and an initial rise of the engine rotation speed Ne is assisted by an electric motor torque Tmg. The angular range θst is desirably, for example, the range of about 30° to 60°, in which relatively large rotational energy is obtained through the ignition start, in crank angle from the compression top dead center; however, the ignition start is possible at about 90° as well.

The intake valve drive device 89 also has the function of changing the open/close timing (valve open timing and valve close timing) of each intake valve 88 as needed, and, for example, functions as a variable valve timing mechanism that advances or retards the open/close timing of each intake valve 88. The open/close timing of each intake valve 88 is the valve open timing and valve close timing of each intake valve 88.

For example, when the engine is started through the ignition start, rotational resistance at the very beginning of rotation of the engine 12 is reduced, so, for example, the intake valve drive device 89 is controlled so as to maximally shift the open/close timing, specifically, at least the valve close timing, of each intake valve 88 in a retardation direction within an adjustable range. Various operation principles of the intake valve drive device 89 are generally known. For example, the intake valve drive device 89 maybe a cam mechanism that is synchronized with rotation of the crankshaft 26 and that opens or closes each intake valve 88 by selectively using any one of a plurality of cams having mutually different shapes through hydraulic control or electric control. Alternatively, the intake valve drive device 89 may be configured to open or close each intake valve 88 by utilizing both a cam mechanism that is synchronized with rotation of the crankshaft 26 and a mechanism that corrects the operation of a cam of the cam mechanism through hydraulic control or electric control. The intake valve drive device 89 that functions as the variable valve timing mechanism just needs to be able to change at least the valve close timing; however, in the present embodiment, in terms of its mechanical structure, the intake valve drive device 89 is configured to, when the valve close timing of each intake valve 88 is changed, change the valve open timing of each intake valve 88 in the same direction as the direction in which the valve close timing is changed. That is, the intake valve drive device 89 integrally changes the valve open timing and valve close timing of each intake valve 88.

In the hybrid vehicle 8, for example, at the time of shifting from the motor drive mode to the engine drive mode, the engine 12 is started by increasing the engine rotation speed Ne using the electric motor torque Tmg through slip engagement of the engine separating clutch K0.

During vehicle deceleration in which a foot brake is depressed or during coasting in which driver's vehicle braking operation and accelerating operation are released, the electronic control unit 58 executes electric motor regeneration control for supplying the electrical storage device 57 with regenerative energy obtained by braking the traveling vehicle 8 through regenerative operation of the electric motor MG Specifically, in the electric motor regeneration control, power transmission between the engine 12 and the drive wheels 24 is interrupted by releasing the engine separating clutch K0, the engine 12 is stopped, and the electric motor MG is operated for regeneration by inertial energy of the vehicle 8. The inertial energy is regenerated as electric power, and the electrical storage device 57 is charged with the electric power from the electric motor MG. During the electric motor regeneration control, the lockup clutch LU is engaged.

The vehicle 8 includes a control system as illustrated in FIG. 1. The electronic control unit 58 shown in FIG. 1 functions as a control device (or a controller included in the control device) for controlling the drive device 10, and is configured to include a so-called microcomputer. As shown in FIG. 1, the electronic control unit 58 is supplied with various input signals that are detected by sensors provided on the hybrid vehicle 8. For example, a signal that indicates an accelerator operation amount Acc, that is, a depression amount of an accelerator pedal 71, a signal that indicates a rotation speed Nmg of the electric motor MG (electric motor rotation speed Nmg), a signal that indicates the rotation speed Ne of the engine 12 (engine rotation speed Ne), a signal that indicates a rotation speed Nt of the turbine impeller 16t of the torque converter 16 (turbine rotation speed Nt), a signal that indicates a vehicle speed V, a signal that indicates the throttle opening degree θth of the engine 12, a signal that indicates a rotation position, that is, a crank angle of the engine output shaft (crankshaft) 26, a signal that indicates a temperature TEMPw of coolant of the engine 12 (engine coolant temperature TEMPw), that is, an engine temperature, a signal that indicates a charge level (state of charge) SOC of the electrical storage device 57, and the like, are input to the electronic control unit 58. The accelerator operation amount Acc is detected by an accelerator operation amount sensor 60.

The electric motor rotation speed Nmg is detected by an electric motor rotation speed sensor 62. The engine rotation speed Ne is detected by an engine rotation speed sensor 64. The turbine rotation speed Nt is detected by a turbine rotation speed sensor 66. The vehicle speed V is detected by a vehicle speed sensor 68. The throttle opening degree θth is detected by a throttle opening degree sensor 70. The crank angle is detected by a crank angle sensor 72. The engine coolant temperature TEMPw is detected by an engine coolant temperature sensor 74. The state of charge SOC is obtained from the electrical storage device 57. Here, as is apparent from FIG. 1, the electric motor rotation speed Nmg detected by the electric motor rotation speed sensor 62 is the same as the rotation speed (pump rotation speed) Np of the pump impeller 16p in the torque converter 16, that is, the input rotation speed of the torque converter 16. The turbine rotation speed Nt detected by the turbine rotation speed sensor 66 is the output rotation speed of the torque converter 16, and is the same as a rotation speed Natin, that is, a transmission input rotation speed Natin, of a transmission input shaft 19 in the automatic transmission 18. A rotation speed Natout, that is, a transmission output rotation speed Natout, of the output shaft 20 of the automatic transmission 18 (hereinafter, referred to as transmission output shaft 20) corresponds to the vehicle speed V. The positive direction of each of the engine torque Te and the electric motor torque Tmg is the same as the rotation direction in which the engine 12 is driven.

Various output signals are supplied from the electronic control unit 58 to devices provided in the hybrid vehicle 8.

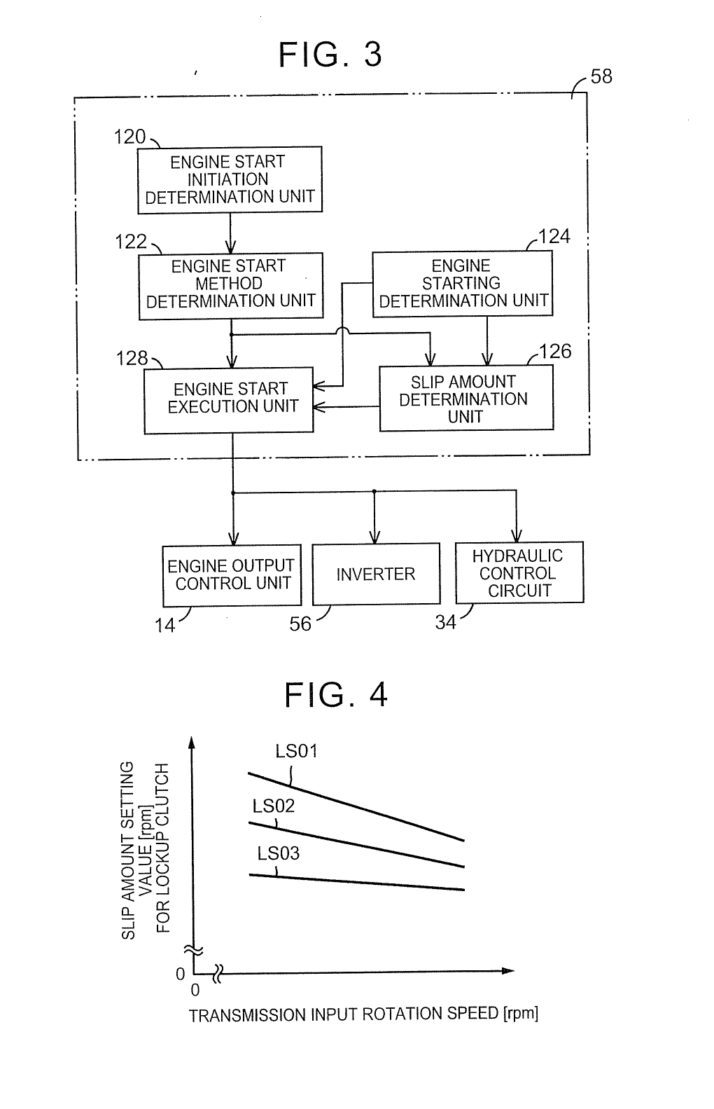

When the electronic control unit 58 according to the present embodiment shifts from the motor drive mode to the engine drive mode, the electronic control unit 58 starts the engine 12 by slipping the engine separating clutch K0 and igniting the engine, and, at this time, slips the lockup clutch LU. When the electronic control unit 58 starts the engine 12, the electronic control unit 58 selects any one of a first engine start method, a second engine start method and a third engine start method as needed on the basis of a predetermined condition, and starts the engine with the use of the selected engine start method. In the first engine start method, ignition of the engine 12 is initiated simultaneously with initiation of a slip of the engine separating clutch K0 or before the initiation of the slip. In the second engine start method, ignition of the engine 12 is initiated within a period from initiation of a slip of the engine separating clutch K0 to when the engine separating clutch K0 is completely engaged. In the third engine start method, ignition of the engine 12 is initiated after the engine separating clutch K0 has been completely engaged from a state where the engine separating clutch K0 is slipped. The electronic control unit 58 selects any one of mutually different engine start methods in starting the engine 12 in this way, so the electronic control unit 58 changes a slip amount DNslip (=Np−Nt) by which the lockup clutch LU is slipped in order to achieve both avoidance of an engagement shock of the lockup clutch LU and fuel economy on the basis of the selected engine start method. A relevant portion of the control functions will be described below with reference to FIG. 3. The first engine start method is specifically an engine start method through the ignition start.

FIG. 3 is a functional block diagram for illustrating the relevant portion of the control functions provided in the electronic control unit 58. As shown in FIG. 3, the electronic control unit 58 functionally includes an engine start initiation determination unit 120, an engine start method determination unit 122, an engine starting determination unit 124, a slip amount determination unit 126 and an engine start execution unit 128.

The engine start initiation determination unit 120 determines whether there is an engine start request that is a request to start the engine 12 when the drive mode of the vehicle 8 is the motor drive mode, for example, when the vehicle 8 is in the motor traveling. For example, when the accelerator operation amount Acc increases during the motor traveling and a required output cannot be satisfied by only the electric motor MG any more, the engine start request is issued in order to change from the motor traveling to the engine traveling.

When the engine start initiation determination unit 120 has determined that there is the engine start request, the engine start method determination unit 122 selects and determines any one of the first engine start method, the second engine start method and the third engine start method as the method of starting the engine 12 at the time of shifting from the motor drive mode to the engine drive mode. At this time, when it is possible to start the engine 12 with the use of the first engine start method, the engine start method determination unit 122 selects the first engine start method in priority to the second and third engine start methods. For example, the engine start method determination unit 122 determines whether an empirically preset ignition start initiation condition is satisfied on the basis of the engine coolant temperature TEMPw, the crank angle of the stopped engine 12, and the like. When the ignition start initiation condition is satisfied, it is determined that it is allowed to start the engine 12 through the ignition start. When the ignition start initiation condition is satisfied, the engine start method determination unit 122 selects the engine start method that uses the ignition start, that is, the first engine start method. When the engine start method determination unit 122 does not select the first engine start method, the engine start method determination unit 122 selects the second or third engine start method. For example, when the engine coolant temperature TEMPw is higher than or equal to an empirically warm-up completion temperature determination value that is preset such that it is allowed to determine completion of warm-up of the engine 12, the second engine start method is selected; whereas, when the engine coolant temperature TEMPw is lower than the warm-up completion temperature determination value, the third engine start method is selected.

The engine starting determination unit 124 determines whether the vehicle 8 is starting the engine 12. For example, from when the engine start request is issued in the motor drive mode to when the engine separating clutch K0 is completely engaged, the vehicle 8 is starting the engine 12. It is determined that the engine separating clutch K0 has been completely engaged when the engine separating clutch K0 is actuated in the engaging direction and the electric motor rotation speed Nmg and the engine rotation speed Ne are synchronized with each other.

When the engine starting determination unit 124 has determined that the vehicle 8 is starting the engine 12 and the engine start method determination unit 122 has determined the method of starting the engine 12, the slip amount determination unit 126 determines a slip amount setting value DNslipt (target slip amount DNslipt) that is a target value of the slip amount DNslip by which the lockup clutch LU is slipped while the engine 12 is being started. Specifically, the slip amount determination unit 126 determines the slip amount setting value DNslipt by consulting a slip amount setting value map on the basis of the sequentially detected transmission input rotation speed Natin (=turbine rotation speed Nt). The slip amount setting value map is an empirically preset correlation between a slip amount setting value DNslipt and a transmission input rotation speed Natin. The slip amount setting value map is empirically preset so as to be able to suppress fuel economy deterioration due to a slip of the lockup clutch LU while avoiding an engagement shock due to complete engagement of the lockup clutch LU when the engine is being started, and is, for example, a map shown in FIG. 4. As shown in FIG. 4, in the slip amount setting value map, on the basis of the same transmission input rotation speed Natin, the slip amount setting value DNslipt that is determined from the correlation of the solid line LS03 is smaller than the slip amount setting value DNslipt that is determined from the correlation of the solid line LS02, and the slip amount setting value DNslipt that is determined from the correlation of the solid line LS02 is smaller than the slip amount setting value DNslipt that is determined from the correlation of the solid line LS01. In addition, in any of the correlations of the solid lines LS01, LS02, LS03, the slip amount setting value DNslipt reduces as the transmission input rotation speed Natin increases. The slip amount determination unit 126 determines the slip amount setting value DNslipt from the correlation of the solid line LS01 when the engine start method determined by the engine start method determination unit 122 is the first engine start method, determines the slip amount setting value DNslipt from the correlation of the solid line LS02 when the determined engine start method is the second engine start method, and determines the slip amount setting value DNslipt from the correlation of the solid line LS03 when the determined engine start method is the third engine start method.

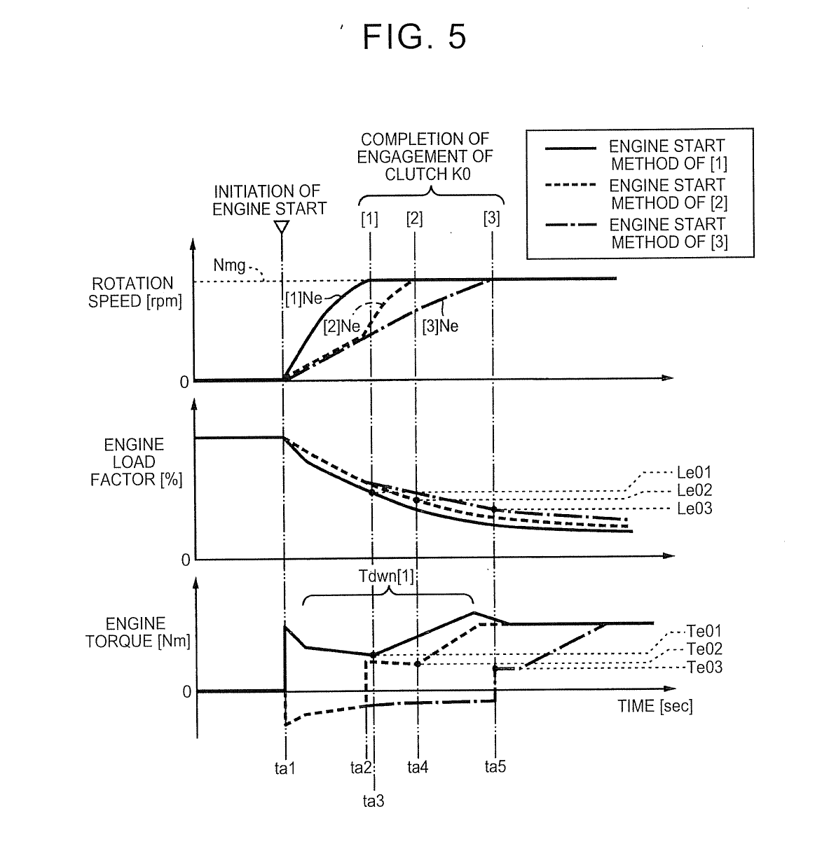

At the time of shifting from the motor drive mode to the engine drive mode by starting the engine 12, the engine start execution unit 128 starts the engine 12 by slipping the engine separating clutch K0 and igniting the engine 12 in a state where the lockup clutch LU is slipped. Specifically, when the engine starting determination unit 124 has determined that the vehicle 8 is starting the engine 12 and the engine start method determination unit 122 has determined the method of starting the engine 12, the engine start execution unit 128 starts the engine 12. At this time, more specifically, the engine start execution unit 128 stats the engine 12 with the use of one of the first to third engine start methods, determined by the engine start method determination unit 122, and controls the engagement hydraulic pressure of the lockup clutch LU such that the slip amount DNslip of the lockup clutch LU becomes the slip amount setting value DNslipt determined by the slip amount determination unit 126. As is apparent from FIG. 4 described above, the engine start execution unit 128 controls the slip amount DNslip such that the slip amount DNslip becomes the slip amount setting value DNslipt, so the engine start execution unit 128 reduces the slip amount DNslip as the transmission input rotation speed Natin (=turbine rotation speed Nt) increases. The slip amount DNslip of the lockup clutch LU is reduced when the engine is started with the use of the third engine start method as compared to when the engine is started with the use of the second engine start method. The slip amount DNslip is reduced when the engine is started with the use of the second engine start method as compared to when the engine is started with the use of the first engine start method. FIG. 5 shows time charts in the case where the engine 12 is started with the use of each of the first to third engine start methods.

FIG. 5 shows the time charts of rotation speeds Ne, Nmg, engine load factor and engine torque Te, in which the solid lines indicate the case where the engine is started with the use of the first engine start method (indicated by [1] in FIG. 5), the dashed lines indicate the case where the engine is started with the use of the second engine start method (indicated by [2] in FIG. 5), and the alternate long and short dashed lines indicate the case where the engine is started with the use of the third engine start method (indicated by [3] in FIG. 5). The engine load factor is the ratio of an actual engine intake air amount to an engine intake air amount (for example, in g/rev) at the time when the engine output is maximum (100%). In FIG. 5, the conditions other than the engine start method are the same even when the engine is started with the use of any one of the first to third engine start methods. Even when the engine is started with the use of any one of the first to third engine start methods, engine torque reduction control for decreasing the engine torque Te by retarding ignition of the engine 12 is executed within a predetermined period from the initiation of ignition of the engine 12 to timing across the timing at which the engine separating clutch K0 is completely engaged, and, for example, Tdwn[1] in FIG. 5 indicates a period during which the engine torque reduction control is executed in starting the engine with the use of the first engine start method.

In FIG. 5, ta1 timing indicates the start initiation timing of the engine 12 in the first to third engine start methods, that is, the timing at which a slip of the engine separating clutch K0 is initiated. Therefore, even when the engine is started with the use of any one of the engine start methods, the engine rotation speed Ne, which has been zero till ta1 timing, starts increasing from ta1 timing. The engine rotation speed Ne is synchronized with the electric motor rotation speed Nmg and the engine separating clutch K0 is completely engaged at ta3 timing in starting the engine with the use of the first engine start method. The engine rotation speed Ne is synchronized with the electric motor rotation speed Nmg and the engine separating clutch K0 is completely engaged at ta4 timing in starting the engine with the use of the second engine start method. The engine rotation speed Ne is synchronized with the electric motor rotation speed Nmg and the engine separating clutch K0 is completely engaged at ta5 timing in starting the engine with the use of the third engine start method.

In addition, ta1 timing is also the timing at which ignition of the engine is, initiated in starting the engine with the use of the first engine start method. Thus, in starting the engine with the use of the first engine start method, a period of time TIMEig from the slip initiation timing of the engine separating clutch K0 to the ignition initiation timing of the engine 12, that is, an ignition initiation required time TIMEig, is zero in FIG. 5. Ignition of the engine is initiated at ta1 timing in starting the engine with the use of the first engine start method, so the engine torque Te increases in a stepwise manner at ta1 timing at the same time.

ta2 timing is the timing at which ignition of the engine is initiated in starting the engine with the use of the second engine start method. Thus, in starting the engine with the use of the second engine start method, the ignition initiation required time TIMEig is a period of time from ta1 timing to ta2 timing in FIG. 5, and is longer than a period of time required to start the engine with the use of the first engine start method. Ignition of the engine is initiated at ta2 timing in starting the engine with the use of the second engine start method, so the engine torque Te is increased in a stepwise manner at ta2 timing at the same time.

In starting the engine with the use of the third engine start method, the engine separating clutch K0 is completely engaged at ta5 timing, so ignition of the engine is initiated. FIG. 5 shows that ignition of the engine is initiated simultaneously with complete engagement of the engine separating clutch K0 at ta5 timing. Strictly speaking, ignition of the engine is initiated after complete engagement of the engine separating clutch K0 has been confirmed, so the timing at which ignition of the engine is initiated comes after the timing at which the engine separating clutch K0 has been completely engaged. Ignition of the engine is initiated at ta5 timing in starting the engine with the use of the third engine start method, so the ignition initiation required time TIMEig is a period of time from ta1 timing to ta5 timing in FIG. 5, and is longer than a period of time required to start the engine with the use of the second engine start method. Ignition of the engine is initiated at ta5 timing in starting the engine with the use of the third engine start method, so the engine torque Te is increased in a stepwise manner at ta5 timing at the same time.

As is apparent from FIG. 5, the ignition initiation required time TIMEig is longer in starting the engine with the use of the third engine start method than in starting the engine with the use of the second engine start method, and is longer in starting the engine with the use of the first engine start method than in starting the engine with the use of the second engine start method. As described above, the engine start execution unit 128 reduces the slip amount DNslip of the lockup clutch LU when the engine is started with the use of the third engine start method as compared to when the engine is started with the use of the second engine start method, and reduces the slip amount DNslip when the engine is started with the use of the second engine start method as compared to when the engine is started with the use of the first engine start method. That is, the engine start execution unit 128 reduces the slip amount DNslip of the lockup clutch LU as the ignition initiation required time TIMEig extends.

The engine load factor at the timing of complete engagement of the engine separating clutch K0 in FIG. 5 is Le01 when the engine is started with the use of the first engine start method, Le02 when the engine is started with the use of the second engine start method, and Le03 when the engine is started with the use of the third engine start method. When the engine load factor reduces, the absolute value of the engine torque Te also reduces accordingly. The engine torque Te at the timing of complete engagement of the engine separating clutch K0 is Te01 when the engine is started with the use of the first engine start method, Te02 when the engine is started with the use of the second engine start method, and Te03 when the engine is started with the use of the third engine start method. As is apparent from the magnitude relationship among Te01, Te02, Te03 (Te01>Te02>Te03), as the ignition initiation required time TIMEig that is different among the engine start methods extends, the absolute value of the engine torque Te at the timing of complete engagement of the engine separating clutch K0 reduces. As the absolute value of the engine torque Te reduces; an error of the engine torque Te with respect to a control command value also reduces. Therefore, as the ignition initiation required time TIMEig extends, the controllability of the lockup clutch LU at the timing at the time when the engine separating clutch K0 is completely engaged improves, and the probability of occurrence of an engagement shock due to complete engagement of the lockup clutch LU decreases.

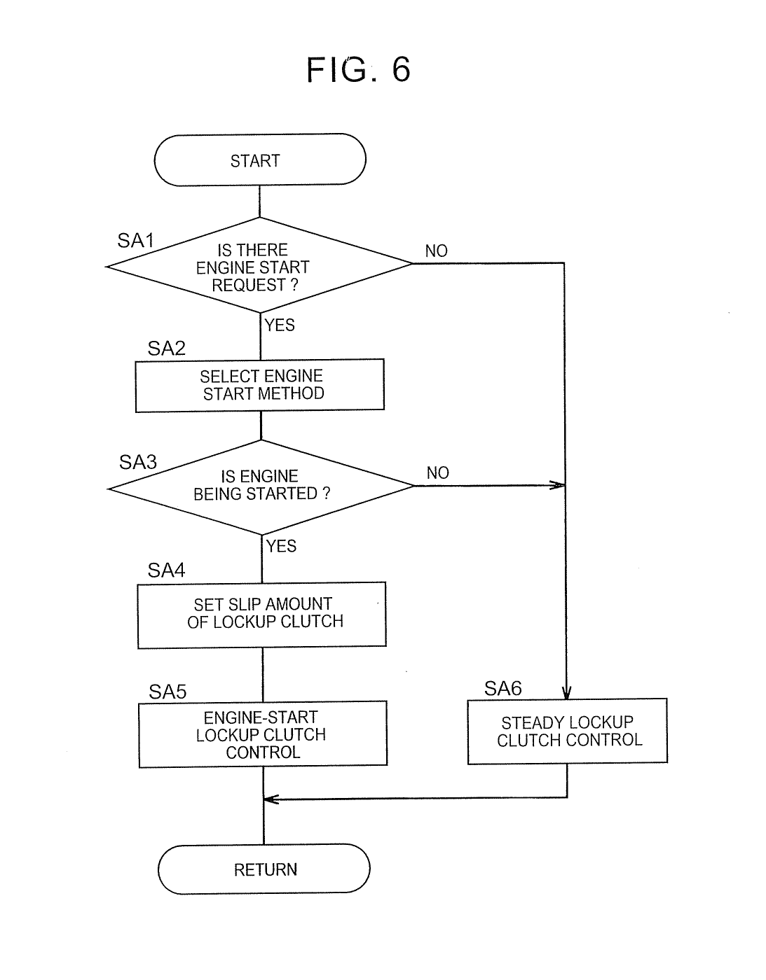

FIG. 6 is a flowchart for illustrating a relevant portion of control operations of the electronic control unit 58, that is, control operations for starting the engine 12 at the time of shifting from the motor drive mode to the engine drive mode. For example, the control operations shown in FIG. 6 are started in the motor drive mode, and are repeatedly executed. The control operations shown in FIG. 6 are solely executed or executed in parallel with other control operations.

First, in step (hereinafter, “step” is omitted) SA1 of FIG. 6, it is determined whether there is an engine start request. When affirmative determination is made in SA1, that is, when there is the engine start request, the process proceeds to SA2. On the other hand, when negative determination is made in SA1, the process proceeds to SA6. SA1 corresponds to the engine start initiation determination unit 120.

In SA2 corresponding to the engine start method determination unit 122, any one of the first engine start method, the second engine start method and the third engine start method is selected. For example, any one of the engine start methods is selected on the basis of the engine coolant temperature TEMPw, the crank angle of the stopped engine 12, and the like. Each of the first to third engine start methods is empirically preset and stored in the electronic control unit 58. Subsequent to SA2, the process proceeds to SA3.

In SA3 corresponding to the engine starting determination unit 124, it is determined whether the engine 12 of the vehicle 8 is starting. When affirmative determination is made in SA3, that is, when the engine 12 of the vehicle 8 is starting, the process proceeds to SA4. On the other hand, when negative determination is made in SA3, the process proceeds to SA6.

In SA4 corresponding to the slip amount determination unit 126, a target value of the slip amount DNslip of the lockup clutch LU is set. That is, the slip amount setting value DNslipt is set on the basis of the transmission input rotation speed Natin by consulting the slip amount setting value map. The transmission input rotation speed Natin based on which the slip amount setting value DNslipt is determined may be a value sequentially detected by the turbine rotation speed sensor 66 or may be, for example, a value at the timing at which the engine start request is issued. Subsequent to SA4, the process proceeds to SA5.

In SA5 corresponding to the engine start execution unit 128, the engine separating clutch K0 is slipped, and the engine 12 is started with the use of the engine start method selected in SA2. At this time, the lockup clutch LU is slipped such that the slip amount DNslip of the lockup clutch LU becomes the slip amount setting value DNslipt determined in SA4. That is, lockup clutch control at the time of the engine start is executed. For example, a slip of the lockup clutch LU is initiated simultaneously with initiation of a slip of the engine separating clutch K0, and the lockup clutch LU is completely engaged from the slipped state after complete engagement of the engine separating clutch K0, more specifically, after a lapse of a predetermined period of time from the timing at which the engine separating clutch K0 has been completely engaged.

In SA6, lockup clutch control at the time when the engine is not started, that is, steady lockup clutch control, is executed.

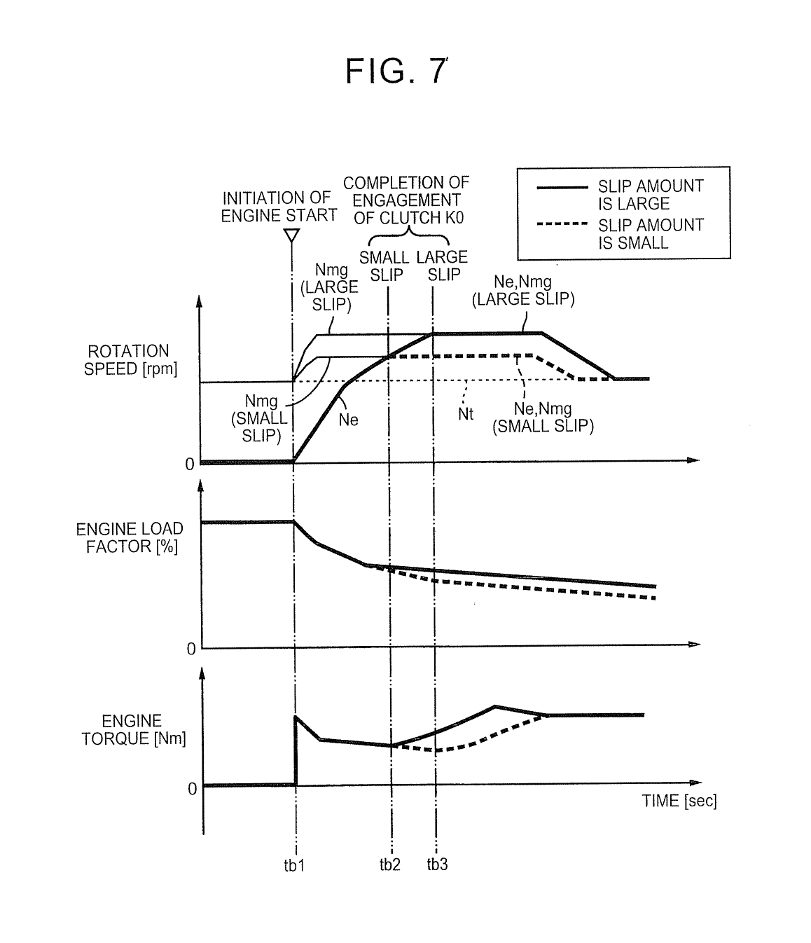

FIG. 7 shows the time charts in which the engine 12 is started with the use of the first engine start method during the motor traveling. FIG. 7 shows the time charts of the rotation speeds Ne, Nmg, Nt, the engine load factor and the engine torque Te in order from above, in which the wide solid lines indicate the case where the slip amount DNslip of the lockup clutch LU is large, and the wide dashed lines indicate the case where the slip amount DNslip is small, specifically, the case where the slip amount DNslip is smaller than that of the wide solid lines. In FIG. 7, the conditions other than the slip amount DNslip are the same in any of the time charts indicated by the wide solid lines and the time charts indicated by the wide dashed lines.

In FIG. 7, tb1 timing indicates the timing at which the engine start with the use of the first engine start method is initiated by the engine start execution unit 128, that is, the timing at which a slip of the engine separating clutch K0 is initiated. Therefore, the engine rotation speed Ne, which has been zero till tb1 timing, starts increasing from tb1 timing. In addition, tb1 timing is also the timing at which ignition of the engine is initiated by the engine start execution unit 128, so the engine torque Te is increased in a stepwise manner at tb1 timing simultaneously with the initiation of ignition of the engine.

The engine start execution unit 128 initiates a slip of the engine separating clutch K0 from tb1 timing, so the engine start execution unit 128 initiates a slip of the lockup clutch LU from tb1 timing in any of the time charts indicated by the wide solid lines and the time charts indicated by the wide dashed lines. The engine start execution unit 128 completely engages the engine separating clutch K0, which has been slipped from tb1 timing, at tb2 timing in the case indicated by the wide dashed lines where the slip amount DNslip is small, and completely engages the engine separating clutch K0 at tb3 timing in the case indicated by the wide solid lines where the slip amount DNslip is large. The engine start execution unit 128 completely engages the lockup clutch LU, which has been slipped from tb1 timing, at timing delayed from the timing at which the engine separating clutch K0 has been completely engaged in any of the time charts indicated by the wide dashed lines and the time charts indicated by the wide solid lines.

According to the above-described present embodiment, when the electronic control unit 58 shifts from the motor drive mode to the engine drive mode by starting the engine 12, the electronic control unit 58 starts the engine 12 by slipping the engine separating clutch K0 and igniting the engine 12 in a state where the lockup clutch LU is slipped. Here, in starting the engine of the vehicle 8, as the ignition initiation required time TIMEig reduces, an initial rise of the engine torque Te immediately after initiation of ignition of the engine 12 is steep and engine torque fluctuations increase, so the controllability of the engine torque Te is poor. Therefore, for example, when the engine torque Te immediately after initiation of ignition of the engine 12 becomes temporarily smaller than the command value and the slip amount DNslip of the lockup clutch LU is insufficient for the temporary engine torque fluctuations, the lockup clutch LU being slipped can be inadvertently completely engaged, and, as a result, an engagement shock can occur. In contrast to this, when the electronic control unit 58 shifts from the motor drive mode to the engine drive mode by starting the engine 12, the slip amount DNslip of the lockup clutch LU is reduced as the ignition initiation required time TIMEig from the slip initiation timing of the engine separating clutch K0 to the ignition initiation timing of the engine 12 extends. That is, as the controllability of the engine torque Te at the time of the engine start deteriorates, the slip amount DNslip of the lockup clutch LU is increased, so it is possible to avoid occurrence of the engagement shock by the adequate slip amount DNslip. In addition, as the ignition initiation required time TIMEig extends, the controllability of the engine torque Te improves and an engagement shock of the lockup clutch LU becomes hard to occur, so it is possible to improve fuel economy by reducing the slip amount DNslip of the lockup clutch LU accordingly. In this way, it is possible to achieve both fuel economy and drivability at the time of shifting from the motor drive mode to the engine drive mode. In the present embodiment, the length of the ignition initiation required time TIMEig based on which the slip amount DNslip of the lockup clutch LU is determined depends on which one of the first to third engine start methods is used to start the engine 12, so the length of the ignition initiation required time TIMEig is fixed at the timing at which the method of starting the engine 12 is determined.

According to the present embodiment, as shown in FIG. 4, the electronic control unit 58 reduces the slip amount DNslip of the lockup clutch LU as the transmission input rotation speed Natin, that is, the output rotation speed of the torque converter 16, increases. Here, when the engine rotation speed Ne that is increased at the time of the engine start, for example, the engine rotation speed Ne at the timing at which the engine separating clutch K0 is completely engaged, is low, the startability of the engine 12 deteriorates. However, even when the transmission input rotation speed Natin is so low that the startability of the engine 12 is deteriorated, the engine rotation speed Ne is increased to a certain high speed due to a slip of the lockup clutch LU at the time of the engine start, so it is possible to suppress deterioration of engine startability due to the low transmission input rotation speed Natin.

If the slip amount DNslip of the lockup clutch LU remains unchanged, the width of increase by which the engine rotation speed Ne is increased from zero at the time of the engine start increases as the transmission input rotation speed Natin increases, so a period of time required to completely engage the engine separating clutch K0 extends. The engine load factor reduces with a lapse of time at the time of the engine start (see FIG. 5 or FIG. 7), so an engagement shock due to complete engagement of the lockup clutch LU becomes hard to occur with the lapse of time. Thus, it is possible to achieve both avoidance of the engagement shock and fuel economy at the time of shifting from the motor drive mode to the engine drive mode.

According to the present embodiment, the electronic control unit 58 starts the engine 12 with the use of any one of the first engine start method (the engine start method through the ignition start), the second engine start method and the third engine start method. In the first engine start method, ignition of the engine 12 is initiated simultaneously with initiation of a slip of the engine separating clutch K0 or before the initiation of the slip. In the second engine start method, ignition of the engine 12 is initiated within a period from when a slip of the engine separating clutch K0 is initiated to when the engine separating clutch K0 is completely engaged. In the third engine start method, ignition of the engine 12 is initiated after the engine separating clutch K0 has been completely engaged from a state where the engine separating clutch K0 is slipped. As shown in the slip amount setting value map of FIG. 4, the electronic control unit 58 reduces the slip amount DNslip of the lockup clutch LU when the electronic control unit 58 starts the engine 12 with the use of the third engine start method as compared to when the electronic control unit 58 starts the engine 12 with the use of the second engine start method. The slip amount DNslip of the lockup clutch LU is reduced when the engine 12 is started with the use of the second engine start method as compared to when, the engine 12 is started with the use of the first engine start method. Thus, the slip amount DNslip of the lockup clutch LU is set to an appropriate amount on the basis of a specific engine start method, so, even when any one of the engine start methods is employed, it is possible to achieve both fuel economy and drivability at the time of shifting from the motor drive mode to the engine drive mode.

The embodiment of the invention is described in detail with reference to the accompanying drawings; however, the above embodiment is only illustrative. The invention may be modified or improved in various forms on the basis of the knowledge of persons skilled in the art.

For example, in the above-described embodiment, the automatic transmission 18 is a step-shift transmission; instead, the automatic transmission 18 may be a continuously variable transmission (CVT) that is able to continuously vary a speed ratio. The automatic transmission 18 may not be provided.

In the above-described embodiment, the engine 12 is a V-engine; instead, the engine 12 may be an engine of another type, such as a straight engine and a horizontally opposed engine. The engine 12 does not need to be limited to an eight-cylinder type. The engine 12 may be, for example, a three-cylinder engine, a four-cylinder engine, a six-cylinder engine or a ten-cylinder engine.

In the above-described embodiment, fuel that is used in the engine 12 is gasoline; instead, the fuel may be ethanol or a mixed fuel of ethanol and gasoline, or may be hydrogen, LPG, or the like.

In the above-described embodiment, the engine 12 is a direct-injection engine; instead, the engine 12 may be not such a direct-injection engine but, for example, an engine that injects fuel into the intake passage 86. When the engine 12 is not a direct-injection engine, the ignition start cannot be carried out, so, for example, the method of starting the engine 12 is determined to one of the second and third engine start methods.

In the above-described embodiment, the method of starting the engine 12 is selected from among the first to third engine start methods; however, the start method does not need to be limited to those three patterns. For example, another engine start method may be selected.

In the above-described embodiment, as shown in FIG. 1, the engine 12 and the electric motor MG are provided along the same axis. Instead, the electric motor MG may be provided along an axis different from the axis of the engine 12 and may be operatively coupled between the engine separating clutch K0 and the torque converter 16 via a transmission device, a chain, or the like.

In the above-described embodiment, the torque converter 16 is used as a fluid transmission device; instead, for example, the torque converter 16 may be replaced with a fluid coupling having no torque amplifying action.

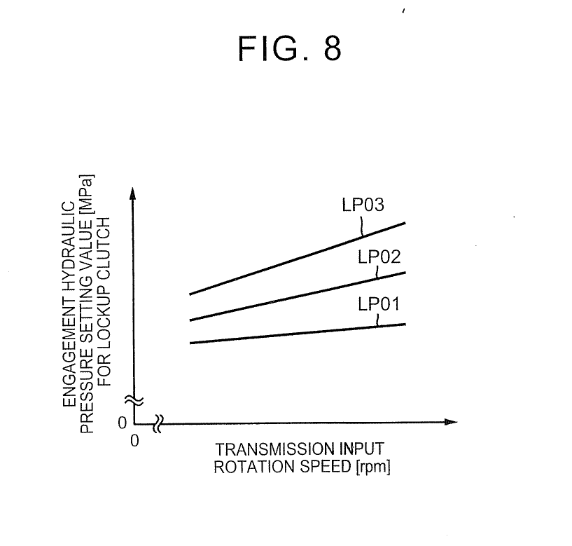

In the above-described embodiment, the slip amount setting value DNslipt is determined in SA4 of FIG. 6 and then the slip amount DNslip of the lockup clutch LU is controlled so as to coincide with the slip amount setting value DNslipt in subsequent SA5. However, the slip amount setting value DNslipt, that is, the target value of the slip amount DNslip, does not need to be directly determined. For example, instead of the above configuration, an engagement hydraulic pressure setting value that is a target value of the engagement hydraulic pressure of the lockup clutch LU may be determined in SA4. In this case, the correlation between the engagement hydraulic pressure setting value and the transmission input rotation speed Natin, that is, an engagement hydraulic pressure setting value map, is empirically preset as in the case of the slip amount setting value map. The engagement hydraulic pressure setting value is determined in SA4 on the basis of the transmission input rotation speed Natin by consulting the engagement hydraulic pressure setting value map, and the engagement hydraulic pressure of the lockup clutch LU is controlled so as to coincide with the engagement hydraulic pressure setting value in SA5. Thus, the slip amount DNslip is adjusted as in the case where the slip amount setting value DNslipt is determined. An example of the engagement hydraulic pressure setting value map is shown in FIG. 8. In the engagement hydraulic pressure setting value map shown in FIG. 8, on the basis of the same transmission input rotation speed Natin, the engagement hydraulic pressure setting value that is determined from the correlation of the solid line LP03 is larger than the engagement hydraulic pressure setting value that is determined from the correlation of the solid line LP02, and the engagement hydraulic pressure setting value that is determined from the correlation of the solid line LP02 is larger than the engagement hydraulic pressure setting value that is determined from the correlation of the solid line LP01. In any one of correlations of the solid lines LP01, LP02, LP03, the engagement hydraulic pressure setting value increases as the transmission input rotation speed Natin increases. The engagement hydraulic pressure setting value is determined from the correlation of the solid line LP01 in SA4 when the engine start method selected in SA2 in the flowchart of FIG. 6 is the first engine start method. The engagement hydraulic pressure setting value is determined from the correlation of the solid line LP02 in SA4 when the selected engine start method is the second engine start method. The engagement hydraulic pressure setting value is determined from the correlation of the solid line LP03 in SA4 when the selected engine start method is the third engine start method.

The first engine start method may be a method in which the engine is started through the ignition start by carrying out ignition while fuel is injected into a cylinder of the engine from the very beginning of rotation of the engine.

In the ignition start, fuel may be initially injected into one of the plurality of cylinders of the direct-injection engine, of which a piston position is in an expansion stroke, and may be ignited.

What is claimed is:

1. A control device for a vehicle including an engine, an electric motor, an engine separating clutch and a fluid transmission device, the control device comprising:
a controller configured to, at the time of shifting from a motor drive mode to an engine drive mode by starting the engine in the motor drive mode, start the engine by slipping the engine separating clutch and igniting the engine in a state where a lockup clutch included in the fluid transmission device is slipped, the fluid transmission device being interposed between the electric motor and a drive wheel, the engine separating clutch being configured to selectively couple the engine to the electric motor, only the electric motor being a drive source in the motor drive mode, the engine being a drive source in the engine drive mode, and the controller being configured to, at the time of the shifting, reduce a slip amount of the lockup clutch as a period of time from timing at which a slip of the engine separating clutch is initiated to timing at which ignition of the engine is initiated extends.

2. The control device according to claim 1, wherein
the controller is configured to reduce the slip amount of the lockup clutch as a rotation speed of output of the fluid transmission device increases.

3. The control device according to claim 1, wherein
the engine is a direct-injection engine,
the controller is configured to start the engine with the use of any one of a first engine start method, a second engine start method and a third engine start method,
the controller is configured to, in the first engine start method, initiate ignition of the engine simultaneously with initiation of a slip of the engine separating clutch or before the initiation of the slip,
the controller is configured to, in the second engine start method, initiate ignition of the engine within a period from initiation of a slip of the engine separating clutch to when the engine separating clutch is completely engaged,
the controller is configured to, in the third engine start method, initiate ignition of the engine after the engine separating clutch has been completely engaged from a state where the engine separating clutch is slipped,
the controller is configured to reduce the slip amount of the lockup clutch when the engine is started with the use of the third engine start method as compared to when the engine is started with the use of the second engine start method, and
the controller is configured to reduce the slip amount of the lockup clutch when the engine is started with the use of the second engine start method as compared to when the engine is started with the use of the first engine start method.

4. A control method for a vehicle including an engine, an electric motor, an engine separating clutch and a fluid transmission device, the control method comprising:
at the time of shifting from a motor drive mode to an engine drive mode by starting the engine in the motor drive mode, starting the engine by slipping the engine separating clutch and igniting the engine in a state where a lockup clutch included in the fluid transmission device is slipped, the fluid transmission device being interposed between the electric motor and a drive wheel, the engine separating clutch being configured to selectively couple the engine to the electric motor, only the electric motor being a drive source in the motor drive mode, and the engine being a drive source in the engine drive mode; and
at the time of the shifting, reducing a slip amount of the lockup clutch as a period of time from timing at which a slip of the engine separating clutch is initiated to timing at which ignition of the engine is initiated extends.
